(19) United States
(12) Patent Application Publication
(10) Pub. No.: US 2011/0153497 A1
(43) Pub. Date: Jun. 23, 2011

(54) SECURE TRANSACTION SYSTEM AND METHOD BASED ON BIOMETRIC IDENTIFICATION

(75) Inventor: Gary Edward Determan, Maple Grove, MN (US)

(73) Assignee: Honeywell International Inc.

(21) Appl. No.: 12/643,514

(22) Filed: Dec. 21, 2009

(51) Int. Cl. G06Q 40/00; G06K 9/00; G06F 3/033; G06F 3/02

(52) U.S. Cl. 705/44; 382/124; 345/163; 345/168

(57) ABSTRACT

A secure transaction system and method based on biometric identification. One or more biometric sensors (e.g., a fingerprint sensor) can be electronically connected to an input device having one or more operable keys, wherein the input device communicates with the secure transaction system to determine the identity of a user. A biometric feature (e.g., a fingerprint) can be captured and measured, if the operable key is pressed. A biometric signal indicative of the sensed biometric feature can be transmitted to a biometric identification module via a network to compare the biometric signal with stored biometric data. An authentication signal can be provided to the user for accessing a secure application that is communicatively coupled to the transaction system if the sensed biometric signal matches the stored biometric data.

### TECHNICAL FIELD

Embodiments are generally related to biometric systems and techniques. Embodiments are also related to fingerprint sensors. Embodiments are additionally related to the provision of access to a secure application based on biometric identification.

### BACKGROUND OF THE INVENTION

Financial institutions, governmental communities, businesses, hospitals and other such facilities require a means to execute transactions in a secure and expedited manner. Transactions can be processed via a single electronic portal such as, for example, computer, automated teller machines (ATM's), cell phone, cash register, commerce terminal and the like. Such electronic transaction systems typically permit a user to process designated transactions electronically, which substantially improves efficiency and convenience to the user.

Conventional electronic transaction systems typically request a user to provide an identification data such as, a password, a personal identification number (PIN) and so forth in order to authenticate the user and approve the proposed transaction(s) in a secured manner. Such transaction systems may often require the user to enter the identification data periodically for authentication and to acquire access to subsequently perform a number of transactions. The problem associated with such transaction systems is that the identification data can be forgotten, lost, stolen, and/or easily accessed by an unauthorized person. Additionally, the creation of such identification data has been limited in many situations by the failure of conventional security measures to reliably permit the identity of users to be verified.

Based on the foregoing, it is believed that a need exists for an improved system and method for providing a secure transaction based on biometric identification. A need also exists for an improved fingerprint sensor, as described in greater detail herein.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved biometric system and method.

It is another aspect of the disclosed embodiments to provide for an improved secure transaction system and method based on biometric identification.

It is a further aspect of the disclosed embodiments to provide for an improved fingerprint sensor in association with the secure transaction system.

The aforementioned aspects and other objectives and advantages can now be achieved as described herein. A secure transaction system and method based on biometric identification is disclosed. A fingerprint sensor can be coupled with respect to at least one operable key associated with an input device (e.g., keyboard, keypad, etc) for communicating with the transaction system to determine the identity of a user. The fingerprint sensor can capture and measure a biometric feature (e.g., fingerprint) if the operable key associated with the biometric sensor is pressed. A biometric signal indicative of the sensed biometric feature can be transmitted to a biometric identification module via a network to compare the biometric signal with stored biometric data. An authentication signal can be provided to the user for accessing a secure application that is communicatively coupled to the transaction system if the sensed biometric signal matches the stored biometric data.

The transaction system can be for example, a data-processing system, a mobile communication device, a cash register, a commerce terminal, and so forth, including combinations thereof, depending upon design considerations. A receiving portion or component associated with the fingerprint sensor can be configured to receive a finger associated with the user. Note that in some embodiments, the fingerprint sensor can be implemented as a capacitance sensor. A silk-screen printed surface associated with the fingerprint sensor, for example, can be employed to directly measure contours associated with the fingerprint by sensing dielectric properties associated with the skin. The fingerprint sensor can detect information with respect to the fingerprint by detecting the ridges and valleys associated with the fingerprint. A storage unit associated with the biometric identification module stores information associated with an identity of at least one authorized user received from the transaction system. A verification engine compares the biometric signal with the stored biometric data and provides access to the secured application if the biometric signal matches the stored biometric data.

### BRIEF DESCRIPTION OF THE DRAWINGS

The accompanying figures, in which like reference numerals refer to identical or functionally-similar elements throughout the separate views and which are incorporated in and form a part of the specification, further illustrate the disclosed embodiments and, together with the detailed description of the invention, serve to explain the principles of the disclosed embodiments.

FIG. 1 illustrates a schematic view of a data-processing system in which an embodiment may be implemented;

FIG. 2 illustrates a schematic view of a software system including an operating system, application software, and a user interface for carrying out an embodiment;

FIG. 3 illustrates a block diagram of a transaction system associated with a fingerprint sensor, in accordance with the disclosed embodiments;

FIG. 4 illustrates a perspective view of a mobile communication device associated with a fingerprint sensor, in accordance with the disclosed embodiments;

FIG. 5 illustrates a high level flow chart of operation illustrating logical operational steps of a method for providing secure transaction based on biometric identification, in accordance with the disclosed embodiments; and

FIG. 6 illustrates a pictorial representation of a biometric system that includes a pointing device such as a mouse, equipped with one or more biometric sensors, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

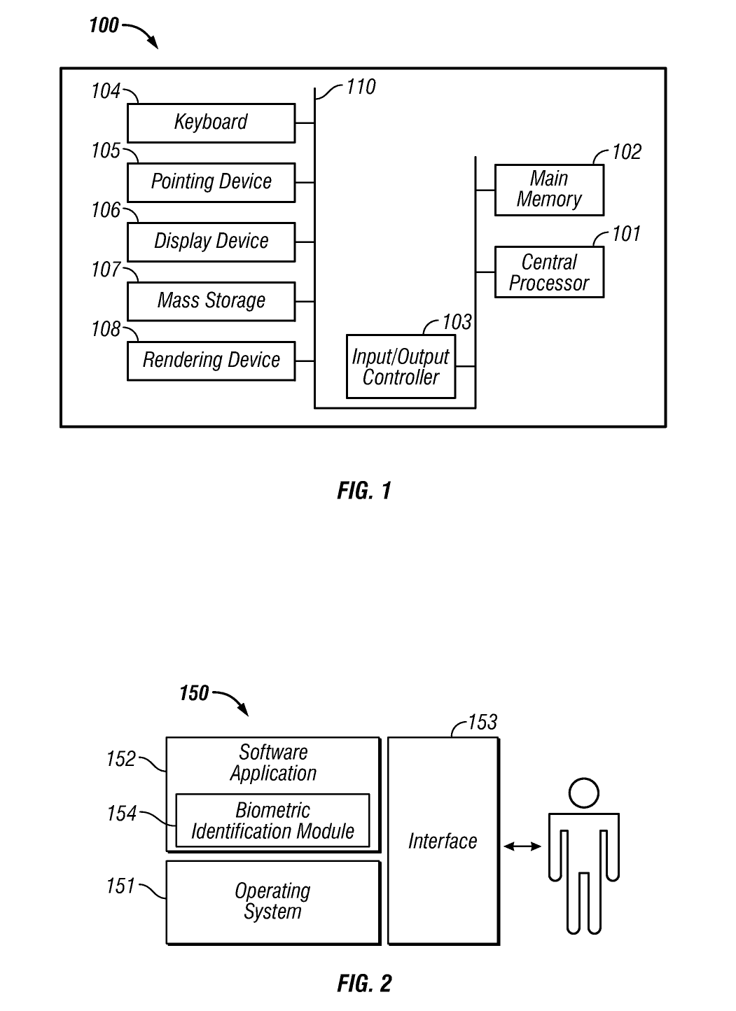

FIGS. 1-2 are provided as exemplary diagrams of data-processing environments in which embodiments of the present invention may be implemented. It should be appreciated that FIGS. 1-2 are only exemplary and are not intended to assert or imply any limitation with regard to the environments in which aspects or embodiments of the disclosed embodiments may be implemented. Many modifications to the depicted environments may be made without departing from the spirit and scope of the present invention.

As illustrated in FIG. 1, the disclosed embodiments can be implemented in the context of a data-processing system 100 comprising, for example, a central processor 101, a main memory 102, an input/output controller 103, a keyboard 104, a pointing device 105 (e.g., mouse, track ball, pen device, or the like), a display device 106, and a mass storage 107 (e.g., hard disk). Additional input/output devices, such as a rendering device 108 (e.g., printer, scanner, fax machine, etc), for example, may be associated with the data-processing system 100 as desired. As illustrated, the various components of data-processing system 100 communicate electronically through a system bus 110 or similar architecture. The system bus 110 may be a subsystem that transfers data between, for example, computer components within data-processing system 100 or to and from other data-processing devices, components, computers, etc.

FIG. 2 illustrates a computer software system 150 for directing the operation of the data-processing system 100 depicted in FIG. 1. Software application 152, stored in main memory 102 and on mass storage 107, generally includes a kernel or operating system 151 and a shell or interface 153. One or more application programs, such as software application 152, can be “loaded” (i.e., transferred from mass storage 107 into the main memory 102) for execution by the data-processing system 100. The data-processing system 100 receives user commands and data through user interface 153; these inputs may then be acted upon by the data-processing system 100 in accordance with instructions from operating module 151 and/or software application 152.

The following discussion is intended to provide a brief, general description of suitable computing environments in which the system and method may be implemented. Although not required, the disclosed embodiments will be described in the general context of computer-executable instructions, such as program modules, being executed by a single computer.

Generally, program modules include but are not limited to routines, subroutines, software applications, programs, objects, components, data structures, etc., that perform particular tasks or implement particular abstract data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

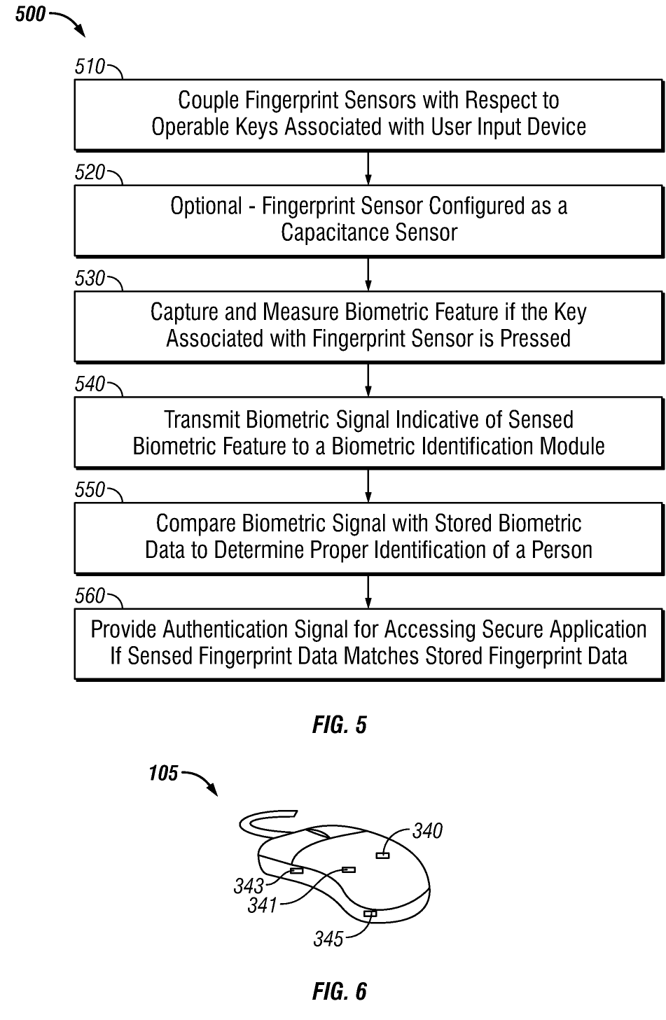

The interface 153, which is preferably a graphical user interface (GUI), can serve to display results, whereupon a user may supply additional inputs or terminate a particular session. In some embodiments, operating system 151 and interface 153 can be implemented in the context of a “Windows” system. It can be appreciated, of course, that other types of systems are potential. For example, rather than a traditional “Windows” system, other operation systems, such as, for example, Linux may also be employed with respect to operating system 151 and interface 152. The software application 152 can include, for example, a biometric identification module 154 for identifying a biometric feature of a person in order to provide a secure transaction. Software application module 152, on the other hand, can include instructions, such as the various operations described herein with respect to the various components and modules described herein, such as, for example, the method 500 depicted in FIG. 5.

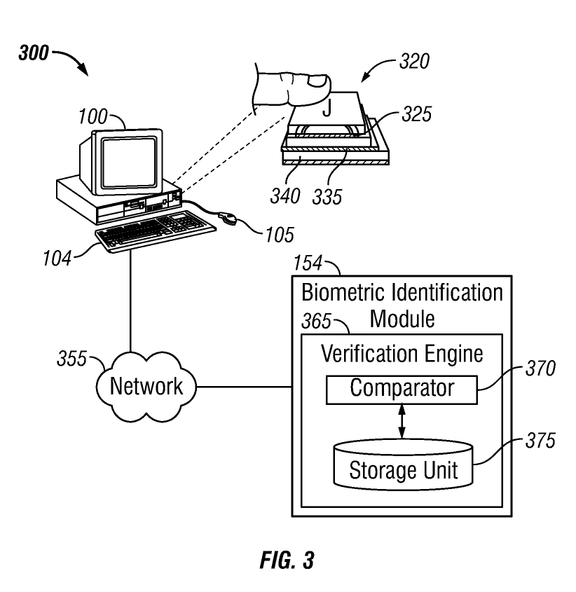

FIG. 3 illustrates a block diagram of a transaction system 300 associated with a biometric identification module 154, in accordance with the disclosed embodiments. Note that in FIGS. 1-5, identical or similar blocks are generally indicated by identical reference numerals. The transaction system 300 can be for example, data processing system 100, a mobile communication device 400, a cash register or a commerce terminal for providing a secure access application, depending upon design considerations. Note that the embodiments discussed herein generally relate to the data processing system. It can be appreciated, however, that such embodiments can be implemented in the context of other systems and designs. The discussion of data processing system, as utilized herein, is presented for general illustrative purposes only.

Biometric identification systems can be employed to verify or recognize an identity of a person based on some physiological characteristic such as, for example, fingerprint, iris pattern and so forth. The transaction system 300 includes the data processing system 100 associated with the input device 104 and the biometric identification module 154. One or more fingerprint sensors such as the fingerprint sensor 340 having a receiving portion 335 can be mounted on the keyboard 104. The fingerprint sensor 340 can be employed to detect a fingerprint of a user by a measuring technology. The fingerprint sensor 340 can also be mounted on a keypad configured in association with the mobile communication device 400, cash register, and/or commerce terminal. The fingerprint sensor 340 can be incorporated in association with one or more frequently used keys such as, for example, ‘J’ key for reading a portion of a finger 320 and detecting one or more fingerprint features associated with the user.

In some embodiments, the fingerprint sensor 340 can be, for example, a capacitance sensor, for capturing and measuring a fingerprint. Such a capacitance sensor can include, for example, includes electrodes 325 configured from a conductive material, such as a silk-screen printed thick film. It can be appreciated that other types of materials may be utilized in place of the suggested material. The fingerprint sensor 340 (e.g., a capacitance sensor) detects information with respect to the fingerprint by detecting the ridges and valleys associated with the fingerprint.

The finger 320 can be pressed against the surface 325 associated with the fingerprint sensor 340 to directly measure the contours of the fingerprint by sensing the dielectric properties of the skin. The fingerprint sensor 340 can capture a fingerprint sample and transmit the fingerprint sample to the biometric identification module 154 via a network 355. The fingerprint sensor 340 can be hidden with respect to the user in a clandestine application. The transaction system 300 can include additional security feature such as an employee ID for each transaction associated with the cash register or the commerce terminal.

In other embodiments, the fingerprint sensor 340 can be hidden. For example, as shown in FIG. 6, the fingerprint sensors 340, 341, 343 and 345 may be hidden or embedded within the mouse 105 (e.g., pointing device). Note that in the example of FIG. 6, fingerprint sensors 340, 341, 343, and 345 are analogous to one another. Thus, the mouse 105 can be equipped with fingerprint sensors 343, 345, which can be hidden at the sides of the mouse 105, where the thumb and fingers of a user typically hold onto the mouse 105. As indicated in the example of FIG. 6, multiple sensors 340, 341, 343, 345 and so forth can be utilized. Such sensors would not necessarily capture a whole fingerprint but would be sufficient to provide data indicating that the same person, for example, is using the mouse 105 or another appropriate input device. Note that for additional clandestine applications, a whole fingerprint can be contrasted by having a user type a particular phrase on a special keyboard.

The biometric identification module 154 includes a verification engine 365 and a storage unit 375. The verification engine 365 further includes a comparator 370 for comparing information related to the sensed fingerprint with the stored fingerprint information. The verification engine 365 also generates an authentication signal if the sensed fingerprint information matches the stored fingerprint information. The storage unit 375 can be included within the biometric identification module 154 for storing information associated with the identity of at least one authorized user which is received from the transaction system 300. Because the locations of these structures are unique to each individual, the comparison can be determined with statistical certainty. The authentication signal for a secured application which is communicatively coupled to the system 300 can be provided if the applied fingerprint matches the stored pattern.

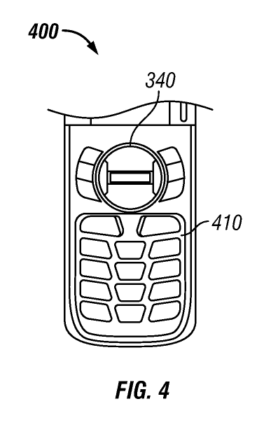

FIG. 4 illustrates a perspective view of a mobile communication device 400 associated with the fingerprint sensor 340, in accordance with the disclosed embodiments. The fingerprint sensor 340 can be placed on an entry key associated with the device keypad 410 that is frequently utilized by the user. Note that the fingerprint sensor may include a variety of different key positions, depending upon design considerations. The fingerprint sensor 340 conveys information associated with the user's identity to the biometric identification module 154 via the network 355. The biometric identification module 154 make a determination that the user attempting to utilize the device 400 is an authorized user upon comparison of actual measured fingerprint with stored information from an authorized list. The information associated with the user's identity may include a signal indicating the attributes of the user's fingerprint so that the mobile communication device 400 may determine whether the user is authorized to access the system. The authentication signal may include information indicating whether the user is authorized to access the device 400.

FIG. 5 illustrates a high level flow chart of operation illustrating logical operational steps of a method 500 for providing secure transaction based on biometric identification, in accordance with the disclosed embodiments. The fingerprint sensor 340 can be configured in association with one or more operable keys associated with an input device, as depicted at block 510. In some embodiments, the fingerprint sensor 340 may be configured as a capacitance sensor, as indicated at block 520. The use of a capacitance sensor for the fingerprint sensor 340 is optional. That is it can be appreciated that other types of sensors, which are not capacitive type sensors, can also be utilized to implement the fingerprint sensor 340.

The biometric feature can be captured and measured each time the key associated with the fingerprint sensor 340 is pressed, as illustrated at block 530. The biometric signal indicative of the sensed biometric feature can be transmitted to the biometric identification module 154, as depicted at block 540. The biometric signal can be compared with stored biometric data to determine proper identification of a person, as indicated at block 550. An authentication signal can be provided to the user for accessing a secure application that is communicatively coupled to the transaction system 300 if the sensed biometric signal matches the stored biometric data, as illustrated at block 560.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system or apparatus including, but not limited to, personal computers, servers, workstations, network computers, main frame computers, routers, switches, Personal Digital Assistants (PDA's), telephones, and any other system capable of processing, transmitting, receiving, capturing and/or storing data. Thus, the data-processing system 100 depicted in FIG. 1, for example, may equally be implemented as PDA, cellular telephone, Smartphone, laptop computer, iPhone, Blackberry type device as well as other types of personal or desktop computers.

It will be appreciated that variations of the above disclosed and other features and functions, or alternatives thereof, can be desirably combined into many other different systems or applications. Also that various presently unforeseen or unanticipated alternatives, modifications, variations or improvements therein can be subsequently made by those skilled in the art which are also intended to be encompassed by the following claims.

What is claimed is:

1. A secure transaction system, comprising:
an input device for communicating with a transaction unit in order to determine an identity of a user, said input device having at least one operable key;
at least one biometric sensor that captures and measures a biometric feature of said user if said at least one operable key of said at least one biometric sensor is pressed is pressed by said user; and
a biometric identification module that receives a biometric signal indicative of said biometric feature and compares said biometric signal with stored biometric data in order to provide an authentication signal if said biometric signal matches said stored biometric data to thereby determine said identity of said user.

2. The system of claim 1 wherein said at least one biometric sensor comprises a fingerprint sensor.

3. The system of claim 2 wherein said fingerprint sensor comprises a capacitance sensor.

4. The system of claim 1 wherein said biometric feature comprises a fingerprint.

5. The system of claim 2 further comprising a receiving component associated with and which communicates electronically with said fingerprint sensor, said receiving component configured to receive a fingerprint associated with said user.

6. The system of claim 3 further comprising a silk-screen printed surface associated with said capacitance sensor to directly measure contours associated with a fingerprint by sensing dielectric properties associated with a finger skin of said user.

7. The system of claim 1 further comprising a storage unit associated with said biometric identification module for storing information associated with an identity of at least one authorized user received from said transaction unit.

8. The system of claim 1 further comprising a verification engine for comparing said biometric signal with said stored biometric data and providing access to a secure application that is communicatively coupled to said transaction unit.

9. The system of claim 1 wherein said transaction unit comprises at least one of the following types of device:
a data-processing device;
a mobile communication device;
a cash register; or
a commerce terminal.

10. The system of claim 1 wherein said input device comprises at least one of the following types of devices:
a keyboard;
a mouse or
a data entry keypad.

11. A secure transaction system, comprising:
an input device for communicating with a transaction unit in order to determine an identity of a user, said input device having at least one operable key;
at least one biometric sensor that captures and measures a biometric feature of said user if said at least one operable key of said at least one biometric sensor is pressed is pressed by said user;
a biometric identification module that receives a biometric signal indicative of said biometric feature and compares said biometric signal with stored biometric data in order to provide an authentication signal if said biometric signal matches said stored biometric data to thereby determine said identity of said user; and
a storage unit associated with said biometric identification module for storing information associated with an identity of at least one authorized user received from said transaction unit.

12. The system of claim 11 further comprising a verification engine for comparing said biometric signal with said stored biometric data and providing access to a secure application that is communicatively coupled to said transaction unit.

13. The system of claim 12 wherein said at least one biometric sensor comprises a fingerprint sensor.

14. The system of claim 13 wherein said fingerprint sensor comprises a capacitance sensor.

15. The system of claim 12 wherein said biometric feature comprises a fingerprint.

16. The system of claim 13 further comprising a receiving component associated with and which communicates electronically with said fingerprint sensor, said receiving component configured to receive a fingerprint associated with said user.

17. The system of claim 14 further comprising a silk-screen printed surface associated with said capacitance sensor to directly measure contours associated with a fingerprint by sensing dielectric properties associated with a finger skin of said user.

18. The system of claim 12 wherein said transaction unit comprises at least one of the following types of device:
a data-processing device;
a mobile communication device;
a cash register; or
a commerce terminal.

19. The system of claim 12 wherein said input device comprises at least one of the following types of devices:
a keyboard;
a mouse or
a data entry keypad.

20. A secure transaction method, comprising:
configuring an input device to communicate with a transaction unit in order to determine an identity of a user, said input device having at least one operable key;
capturing and measuring a biometric feature of said user utilizing at least one biometric sensor, if said at least one operable key of said at least one biometric sensor is pressed is pressed by said user; and
receiving a biometric signal by a biometric identification module, wherein said biometric signal is indicative of said biometric feature and compares said biometric signal with stored biometric data in order to provide an authentication signal if said biometric signal matches said stored biometric data to thereby determine said identity of said user.
